(19) United States
(12) Patent Application Publication
(10) Pub. No.: US 2026/0079499 A1
(43) Pub. Date: Mar. 19, 2026

(54) METHOD AND SYSTEM FOR ENERGY MANAGEMENT IN AN AUTOMATED STORAGE AND RETRIEVAL SYSTEM

(71) Applicant: EXOTEC PRODUCT FRANCE, CROIX (FR)

(72) Inventor: David BARBE, LA MADELEINE (FR)

(73) Assignee: EXOTEC PRODUCT FRANCE, CROIX (FR)

(21) Appl. No.: 19/109,592

(22) PCT Filed: Sep. 8, 2023
(86) PCT No.: PCT/FR2023/051363

§ 371 Date: Mar. 7, 2025

(30) Foreign Application Priority Data
Sep. 20, 2022 (FR) FR2209518

(51) Int. Cl. G05D 1/644; B65G 1/137; G05D 1/65; G05D 1/698; G05D 105/20; G05D 107/70; G05D 109/10

(52) U.S. Cl. CPC G05D 1/644; B65G 1/1373; G05D 1/65; G05D 1/698; G05D 2105/20; G05D 2107/70; G05D 2109/10

(57) ABSTRACT

A method is provided for energy management in an automated storage and retrieval system, including a plurality of autonomous vehicles, the method includes: determining tasks (Lx) to be performed within a predetermined duration (tf); determining a fleet of autonomous vehicles (N) to be mobilized to perform the tasks within the predetermined duration (tf), operating parameters of the autonomous vehicles (Pj) in order to perform the tasks within the predetermined duration (tf), and/or an energy charging strategy of the autonomous vehicles (Cuj) in order to perform the tasks (Lx) within the predetermined duration (tf), such that the amount of energy consumed to perform the tasks (Lx) within the predetermined duration (tf) is minimal.

### TECHNICAL FIELD

This disclosure relates to the field of automated storage and retrieval systems (ASRS) in warehouses.

### BACKGROUND

Automated storage and retrieval systems (ASRS) include autonomous vehicles or AGVs (“Automated Guided Vehicles”). Such AGVs are configured to navigate within a structure in which the storage of items occurs in a completely autonomous manner, meaning without human intervention. The autonomous vehicles move about within the structure in order to place or remove the items.

Conventionally, autonomous vehicles move at a speed that enables them to complete a set of tasks of placing or removing items as quickly as possible, and to connect to a charging station when necessary. However, autonomous vehicles quickly become discharged, and the automated storage and retrieval system consumes considerable energy to recharge them.

Document WO 2020/200821 proposes a monitoring device configured to monitor the available energy, and to modify the charging strategy and/or the travel speed of the autonomous vehicles when the available energy falls below a predetermined threshold. In addition, document WO 20215/8442 describes monitoring the price of energy, and adapting the charging strategy to energy costs.

These solutions effectively make it possible to temporarily limit the amount of energy consumed by the system, as well as the associated costs. However, these strategies are independent of the number of tasks that the autonomous vehicles must perform within an assigned time. When the system operates at reduced energy consumption, the time required to complete all the tasks can increase considerably. The productivity of the system is then reduced. In addition, periods of excess energy consumption may appear, to compensate for the phases of operating at reduced consumption, making the entire system energy-intensive in the long term.

### SUMMARY

This disclosure improves the situation.

A method is provided for energy management in an automated storage and retrieval system, said system comprising a plurality of autonomous vehicles, the method comprising:
determining tasks to be performed within a predetermined duration;
determining a fleet of autonomous vehicles to be mobilized to perform the tasks within the predetermined duration, operating parameters of the autonomous vehicles in order to perform the tasks within the predetermined duration, and/or an energy charging strategy of the autonomous vehicles in order to perform the tasks within the predetermined duration, by: determining an energy loss, the energy loss being a difference between an amount of electrical energy used and an amount of mechanical energy produced during the predetermined duration, for a plurality of combinations of fleet of autonomous vehicles, operating parameters, and/or charging strategy; and selecting the combination that has the smallest difference so that the amount of energy consumed to perform the tasks within the predetermined duration is minimal, at least when the tasks are below a threshold number of tasks.

The energy consumption of the system can thus be adapted to the number of tasks to be performed with within a given time. The energy consumption can be reduced while ensuring that the tasks are completed within the given time.

These steps of determining the fleet of autonomous vehicles, the operating parameters of the autonomous vehicles, and/or the charging strategy of the autonomous vehicles make it possible to evaluate a plurality of theoretical solutions and to compare them to each other on the basis of the energy they would consume, in order to identify the most suitable one (i.e. the one consuming the least energy).

The features set forth in the following paragraphs may optionally be implemented, independently of each other or in combination with each other.

Determining the fleet of autonomous vehicles, the operating parameters of the autonomous vehicles, and/or the charging strategy of the autonomous vehicles may be carried out if the tasks are below the threshold number of tasks, and otherwise may take pre-established default values.

Thus, the fleet of autonomous vehicles, the operating parameters of the autonomous vehicles, and/or the charging strategy may be determined so as to consume less energy only when the conditions so allow, i.e. when the number of tasks to be carried out is sufficiently low and during a defined time. Otherwise, the pre-established default values are able to allow the tasks to be carried out as quickly as possible. The productivity of the system is not compromised.

The operating parameters may comprise at least one of: an acceleration rate, a deceleration rate, and a travel speed. These parameters make it possible to reduce the amount of energy consumed by each autonomous vehicle when it moves about in the warehouse. In the case of the deceleration rate, it is further possible to regenerate energy during braking.

Each autonomous vehicle may be configured to move in a longitudinal direction, a lateral direction, and a vertical direction, and the operating parameters may comprise at least one of: a vertical ascending acceleration rate, a vertical ascending deceleration rate, a vertical descending acceleration rate, and a vertical descending deceleration rate. The ascending function of the autonomous vehicles can thus be exploited to further reduce the amount of energy consumed by the autonomous vehicles. During a descent, it is also possible to regenerate a considerable amount of energy.

Each rate may be a fixed value or a function of the travel speed. In the case of a fixed value, the acceleration and deceleration rates can be determined more easily (the calculations are simplified). This in particular can enable an adaptation of the rates in nearly real time. In the case where they are a function of the travel speed, the acceleration and deceleration rates may be even more optimized so as to further reduce the amount of energy consumed and regenerate more energy.

Defining the charging strategy may comprise selecting a charging current and a charging time. These parameters effectively reduce the amount of electrical energy used to recharge the fleet of autonomous vehicles, in particular by avoiding losses related to charging faster than necessary.

The operating parameters of the autonomous vehicles and/or the charging strategy of the autonomous vehicles may be identical for each autonomous vehicle in the fleet of autonomous vehicles. The determination may thus be simplified. When there is a communal charging strategy, it is also possible for the autonomous vehicle to be recharged indiscriminately at any charging station.

The amount of electrical energy used may be a function of the number of autonomous vehicles, the operating parameters, and the charging strategy. Thus, the amount of electrical energy corresponds to the electrical energy consumed by the system as a whole to perform the tasks. The optimization then becomes global and coordinated and allows economies of scale in energy consumption rather than temporary and local economies which would otherwise lead to overconsumption.

The amount of mechanical energy produced may be a function of the operating parameters. Thus, the amount of mechanical energy produced corresponds to the energy used (the effective energy) by the fleet of autonomous vehicles in order to move around, as opposed to losses.

The energy loss may be determined by simulation or by experimentation. By simulation, the energy loss may be determined using a model of the system. It is possible to test a large number of combinations. By experimentation, the energy loss may be determined in a simpler and more accessible manner. In this case, the system can evolve: it can “learn”.

The combination that presents the lowest energy loss may be stored in a database. Thus, the step of determining the fleet of autonomous vehicles, the operating parameters of the autonomous vehicles, and/or the charging strategy of the autonomous vehicles may be simplified, by browsing the database.

When the predetermined duration is greater than a predetermined limit duration, then a minimum fleet of autonomous vehicles, extreme operating parameters, and/or an extreme charging strategy may be selected. The amount of energy consumed to perform the tasks can be further reduced, since the tasks can be performed over a very long period (equivalent to an infinite period). There is no longer any time constraint on performing the tasks.

According to another aspect, a computer program is proposed comprising instructions for implementing the method when this program is executed by a processor.

According to another aspect, an automated storage and retrieval system is proposed, comprising:
a plurality of autonomous vehicles configured to retrieve and/or store items;
at least one autonomous vehicle charging station; and
a processor configured to control the fleet of autonomous vehicles, the operating parameters of the autonomous vehicles, and/or the charging strategy, by implementing the method.

Each autonomous vehicle may be configured to move in a longitudinal direction, a transverse direction, and a vertical direction. The autonomous vehicles may thus move about in three dimensions in the warehouse, efficiently accessing all the stored items.

### BRIEF DESCRIPTION OF DRAWINGS

Other features, details and advantages will become apparent upon reading the detailed description below, and upon analyzing the attached drawings, in which:

FIG. 1 schematically illustrates an automated storage and retrieval system according to one embodiment.

FIG. 2 schematically illustrates an autonomous vehicle capable of being utilized in the system of FIG. 1 according to one embodiment.

FIG. 3 illustrates a flowchart of a method for energy management capable of being implemented in the system of FIG. 1 according to one embodiment.

FIG. 4 illustrates a graph of tasks as a function of time, according to one embodiment.

FIG. 5 schematically illustrates a comparison between two operating modes of the automated storage and retrieval system of FIG. 1, according to one embodiment.

FIG. 6 illustrates a graph of the travel speed and energy consumption of the autonomous vehicle of FIG. 2 as a function of time, according to one embodiment.

FIG. 7 illustrates a flowchart of a method for determining the fleet of autonomous vehicles, the operating parameters, and the charging strategy, in order to consume a minimum amount of energy, according to one embodiment.

### DETAILED DESCRIPTION

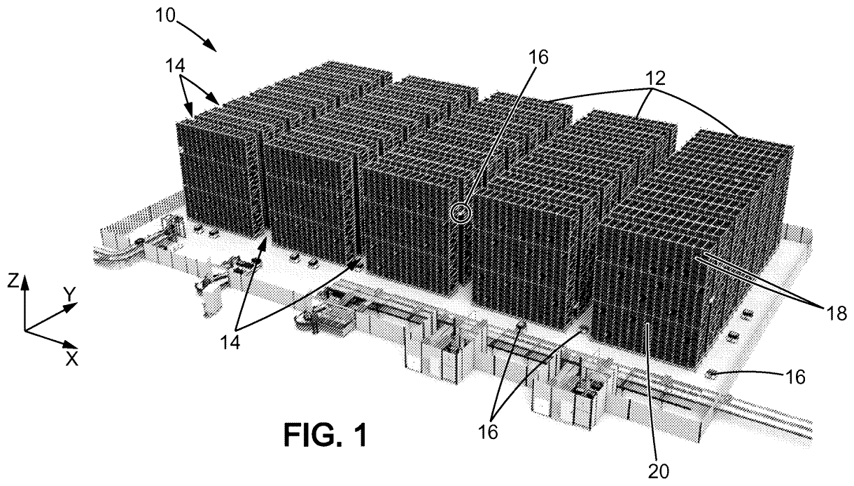

FIG. 1 schematically illustrates an automated storage and retrieval system ASRS. Such a system 10 is used in warehouses for storing items.

System 10 comprises a plurality of storage racks 12 intended to receive the items in order to store them. Storage racks 12 are spaced apart from each other in a longitudinal direction x and in a lateral direction y to form a grid of aisles 14, between which the autonomous vehicles 16 can circulate. Storage racks 12 are for example spaced apart by a distance of 800 mm, 600 mm, or even 400 mm.

Each storage rack 12 comprises a plurality of storage columns 18 arranged in rows. Each storage rack 12 may comprise one or two rows of storage columns 18. Storage columns 18 receive pallets 20 (or other supports/containers such as bins), pallets 20 being superimposed atop one another along storage column 18 (i.e. along the vertical direction z). Pallets 20 receive items, and their superposition allows a high-density storage of items in the warehouse. Autonomous vehicles 16 can use storage columns 18 as a support in order to move in the vertical direction z and access high items.

System 10 further comprises a plurality of autonomous vehicles 16 or AGVs (“Automated Guided Vehicles”). The plurality of autonomous vehicles 16 move in aisles 14 in the longitudinal and lateral directions x,y and in the vertical direction z in order to be able to access all the items stored in the warehouse. Autonomous vehicles 16 may perform tasks of item placement and removal by moving in the longitudinal, lateral, and vertical directions x,y,z.

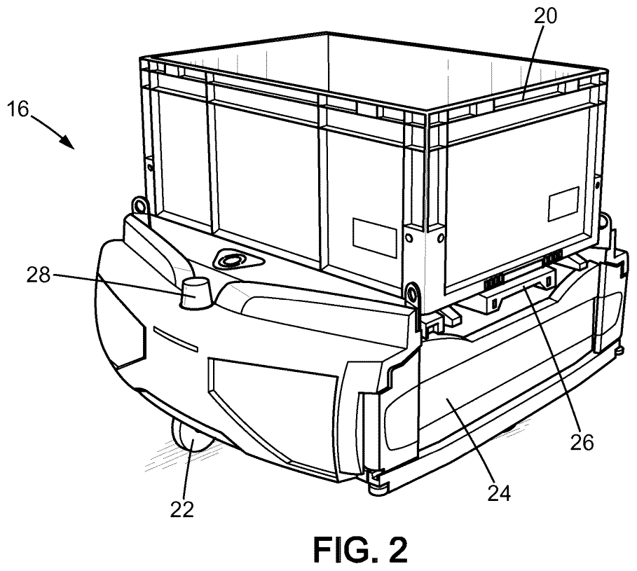

FIG. 2 illustrates an autonomous vehicle 16 in more detail.

Autonomous vehicle 16 comprises advancement means 22, for example in the form of wheels 22, adapted for moving autonomous vehicle 16 in the lateral and longitudinal directions y,x (i.e. movement over the floor). Autonomous vehicle 16 may thus move about in aisles 14 between storage racks 12.

Autonomous vehicle 16 further comprises an ascension system 24 adapted for movement in vertical direction z. In addition to the two planar dimensions generally associated with the floor on which autonomous vehicle 16 moves, there is a vertical third dimension associated with storage racks 12 on which autonomous vehicle 16 is capable of ascending and descending. Ascension system 24 can engage with storage columns 18 of two neighboring storage racks 12 and move along storage columns 18.

Advancement means 22 and ascension system 24 may be driven by a motor (not shown). The motor may for example be configured to reach a travel speed vⱼ of 4 m/s. Travel speed vⱼ may be the travel speed vⱼ in the lateral and longitudinal directions y, x, or the travel speed in the vertical direction z.

Autonomous vehicle 16 further comprises an interface 26 adapted for removing or inserting a pallet 20 from or into a storage rack 12, and for supporting pallet 20. Pallet 20 may be removed from storage rack 12 and transported by autonomous vehicle 16. It is also possible for pallet 20 to be transported by autonomous vehicle 16 and inserted into storage rack 12. Interface 26 may in particular be configured to support loads of up to 30 kg.

Autonomous vehicle 16 may comprise a guidance system 28, for example a laser guidance system 28. Autonomous vehicle 16 may thus determine its location within the warehouse and assess its environment in order to avoid possible obstacles, including other autonomous vehicles 16.

Autonomous vehicle 16 may be powered by an on-board battery (or several; not shown) configured to supply the other elements of autonomous vehicle 16 with electrical energy. System 10 then further comprises at least one charging station (not illustrated). Autonomous vehicle 16 may connect to a charging station in order to recharge the on-board battery. System 10 may comprise a single charging station for recharging all autonomous vehicles 16. Alternatively, system 10 may comprise a plurality of charging stations to enable a plurality of autonomous vehicles 16 to recharge at the same time.

System 10 further comprises a processor adapted to control autonomous vehicles 16 and the at least one charging station, in order to perform tasks Lₓ within a predetermined duration tr. Tasks Lₓ correspond to a number of items X to be removed from (or inserted into) storage racks 12. The tasks may for example be one task (X=1), 10 tasks (X=10), 100 tasks (X=100), or even 1000 tasks (X=1000). Predetermined duration t_{f} corresponds to a period of time during which tasks Lₓ must be performed. Predetermined duration t_{f} may be in hours, days, weeks, or months. Predetermined duration t_{f} is measured from an initial time to.

The processor is configured to select a fleet of autonomous vehicles N. The fleet of autonomous vehicles N corresponds to the number of active autonomous vehicles 16, i.e. the number of autonomous vehicles moving about in the warehouse in order to perform tasks Lₓ. The fleet of autonomous vehicles N may for example be a number between zero autonomous vehicles 16 and a maximum number Nₘₐₓ of autonomous vehicles 16. The maximum number may for example be 10, 20, 50, or even 100 autonomous vehicles 16. The processor may select a fleet of autonomous vehicles N which is adapted for performing the tasks within predetermined duration t_{f}.

It is noted that, in addition to their number, the processor may identify the autonomous vehicles 16 constituting the fleet, in particular when the vehicles are not all identical (different models or versions, different dimensions, wear in certain components including the battery, specific tools, etc.).

The processor is also configured to select operating parameters Pⱼ of fleet of autonomous vehicles N. Operating parameters Pⱼ may be defined by the processor and transmitted to autonomous vehicles 16. Operating parameters Pⱼ, is understood to mean the parameters which enable autonomous vehicles 16 to move about. For example, operating parameters Pⱼ comprise a travel speed vⱼ in the lateral y, longitudinal x, and vertical z directions, an acceleration rate aⱼ in the lateral and longitudinal directions y,x, a deceleration rate dⱼ in the lateral and longitudinal directions y,x, a vertical ascending acceleration rate caⱼ, a vertical ascending deceleration rate cdⱼ, a vertical descending acceleration rate faⱼ, and a vertical descending deceleration rate fdⱼ.

The processor may define operating parameters Pⱼ for each autonomous vehicle j in fleet of autonomous vehicles N. Advantageously, operating parameters Pⱼ which are common to all autonomous vehicles 16 of fleet of autonomous vehicles N facilitate the controlling of autonomous vehicles 16 to perform tasks Lₓ within predetermined duration t_{f}. Alternatively, operating parameters Pⱼ may be defined for each autonomous vehicle j of fleet of autonomous vehicles N. Each autonomous vehicle j of fleet of autonomous vehicles N may have operating parameters Pⱼ specific to it. This solution makes it possible in particular to optimize the use of each autonomous vehicle 16.

One will note that the operating parameters of acceleration rate aⱼ in the lateral and longitudinal directions, deceleration rate dⱼ in the lateral and longitudinal directions x,y, vertical ascending acceleration rate caⱼ, vertical ascending deceleration rate cdⱼ, vertical descending acceleration rate faⱼ, and vertical descending deceleration rate fdⱼ may be constant parameters. Alternatively, the acceleration and deceleration rates may be as functions of the travel speed.

The processor is further configured to define energy charging strategy Cⱼ of autonomous vehicles 16. Charging strategy Cⱼ, is understood to mean in particular a charging time tⱼ and a charging current Iⱼ. Charging time tⱼ corresponds to a period of time, for example in minutes or hours, during which autonomous vehicle 16 is connected to the charging station. Charging current Iⱼ corresponds to the amount of current used to charge the on-board battery of autonomous vehicle 16 during charging time tⱼ. Furthermore, when system 10 comprises a plurality of charging stations, charging strategy Cⱼ. may also comprise a number of active charging stations, i.e. a number of charging stations available for charging autonomous vehicle 16.

The processor may define an energy charging strategy Cⱼ that is common to all the charging stations. Autonomous vehicle 16 may therefore connect to any charging station. Alternatively, the processor may define an energy charging strategy Cⱼ specific to each charging station. It is then possible to use several energy charging strategies Cⱼ simultaneously. In another alternative, the processor may define an energy charging strategy Cⱼ for each autonomous vehicle j of fleet of autonomous vehicles N, independently of the charging station. In this case, the autonomous vehicle j may identify itself to the charging station, and the charging station may adopt the charging strategy Cⱼ specific to the autonomous vehicle j identified.

In an operating mode referred to as “normal”, the processor may select a fleet of autonomous vehicles N, operating parameters of the autonomous vehicles Pⱼ, and a charging strategy Cⱼ, according to pre-established default values. For example, fleet of autonomous vehicles N may be a number of active vehicles Nₙₒᵣₘₐₗ, the operating parameters may be parameters Pⱼₙₒᵣₘₐₗ, and the charging strategy may be a strategy Cⱼₙₒᵣₘₐₗ. “Normal” operation makes it possible to complete all of the item placement or removal tasks as quickly as possible.

In an operating mode referred to as “economy”, the processor may determine a fleet of autonomous vehicles N, operating parameters Pⱼ of fleet of autonomous vehicles N, and a charging strategy Cⱼ, which make it possible to carry out tasks Lₓ within the predetermined duration t_{f} while consuming a reduced amount of energy. Tasks Lₓ are carried out over a longer time (although less than predetermined duration t_{f}) while consuming a minimal amount of energy.

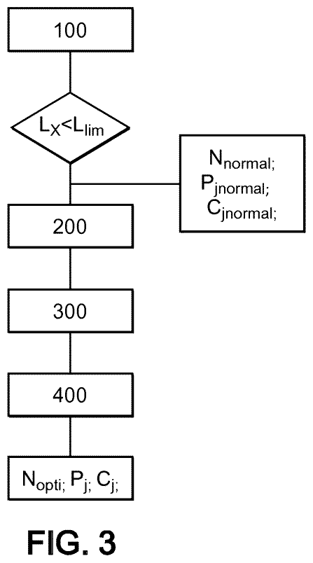

A method for energy management, implemented by the processor described above, is described below with reference to FIG. 3.

The method may be implemented periodically. For example, the method may be implemented each time a set of tasks has been completed by system 10. The method may also be implemented each time new tasks to be performed are assigned to system 10. The method could also be implemented every hour, every day, or every week, depending on the usual frequency at which the tasks to be performed are updated.

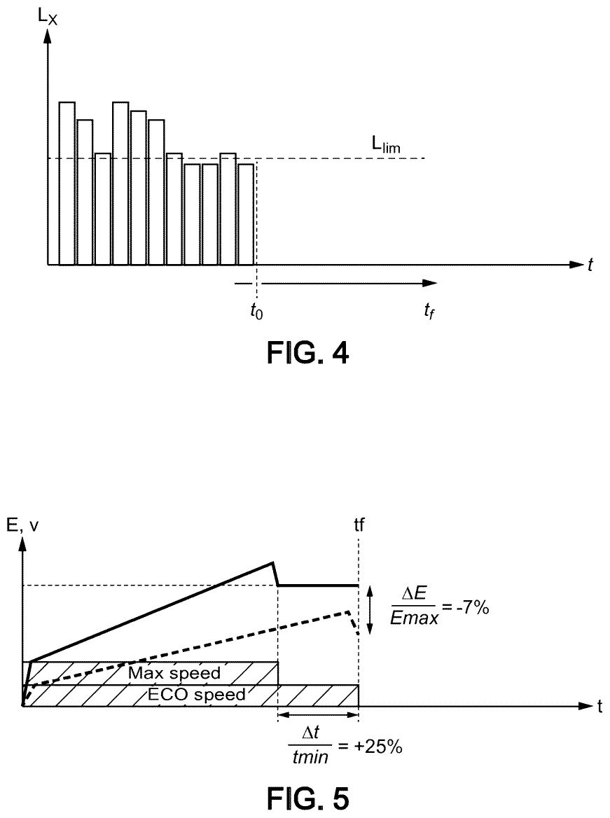

According to a first step 100, tasks Lₓ to be performed within predetermined duration t_{f} are determined. Tasks Lₓ to be performed are determined starting at the present time to. As can be seen in FIG. 4, when tasks Lₓ are less than a threshold number of tasks Lim, it is determined that fleet of autonomous vehicles N, operating parameters Pⱼ, and charging strategy Cⱼ may be modified. Advantageously, it is determined that “economy” mode can be activated while ensuring that tasks Lₓ will be performed within predetermined duration t_{f}. The amount of energy consumed is reduced when the number of tasks is rather low, such as at the end of the day or at the end of the week.

If the number of tasks Lₓ to be performed is greater than the threshold number of tasks Lim, then the values remain at the pre-established default values (Nₙₒᵣₘₐₗ, Pⱼₙₒᵣₘₐₗ, Cⱼₙₒᵣₘₐₗ). System 10 can then continue to perform the tasks as quickly as possible (“normal” operation) when the number of tasks to be performed is large. This situation may for example correspond to a peak in activity. For example, in “normal” operation, travel speed vⱼ may be 4 m/s.

According to a second step 200, when the number of tasks Lₓ is less than the threshold number of tasks Lim, fleet of autonomous vehicles N for performing tasks Lₓ is determined. Fleet of autonomous vehicles N may be determined as a function of tasks Lₓ to be performed and predetermined duration t_{f}. Fleet of vehicles N corresponds to the optimal number of autonomous vehicles Nₒₚₜᵢ to perform tasks Lₓ within predetermined duration t_{f}. Optimal fleet of autonomous vehicles Nₒₚₜᵢ may for example correspond to the minimum number of autonomous vehicles enabling tasks Lₓ to be performed within predetermined duration t_{f}. The reduced number of autonomous vehicles 16 makes it possible to minimize the amount of energy consumed.

Indeed, FIG. 5 compares the consumed electrical power P_{elec} used to perform tasks Lₓ within predetermined duration t_{f} as a function of fleet of autonomous vehicles N. When fleet of autonomous vehicles N is the fleet of autonomous vehicles running in normal operation Nₙₒᵣₘₐₗ (i.e. the fleet of autonomous vehicles pre-established by default), tasks Lₓ are performed within a short time but require electrical energy (solid curve) and therefore significant electrical power P_{elec}. When fleet of autonomous vehicles N is optimal fleet of autonomous vehicles Nₒₚₜᵢ, tasks Lₓ are performed within a longer time but require lower electrical energy (dotted curve) and therefore lower electrical power P_{elec}. Thus, the energy loss E over predetermined duration t_{f} is reduced. Reducing fleet of autonomous vehicles N increases the time to perform tasks Lₓ but reduces the amount of electrical energy consumed over the same duration.

According to a third step 300, operating parameters Pⱼ of fleet of autonomous vehicles N are determined. For example, travel speed vⱼ may be reduced relative to the pre-established default values. Acceleration rate aⱼ in the longitudinal and lateral directions x,y may be reduced. Deceleration rate dⱼ in the longitudinal and lateral directions x,y may be optimized to allow energy regeneration. Since autonomous vehicle 16 is able to move in the vertical direction z, it is advantageous to further reduce the vertical ascending acceleration rate caⱼ. Indeed, ascension is particularly energy-intensive, and reducing vertical ascending acceleration rate caⱼ allows considerably reducing the amount of energy consumed. The vertical descending deceleration rate fdⱼ may also be optimized. A considerable amount of energy may thus be regenerated when the autonomous vehicle descends. These modifications make it possible to minimize the amount of energy consumed by each autonomous vehicle j in fleet of autonomous vehicles N during their movements to perform tasks Lₓ.

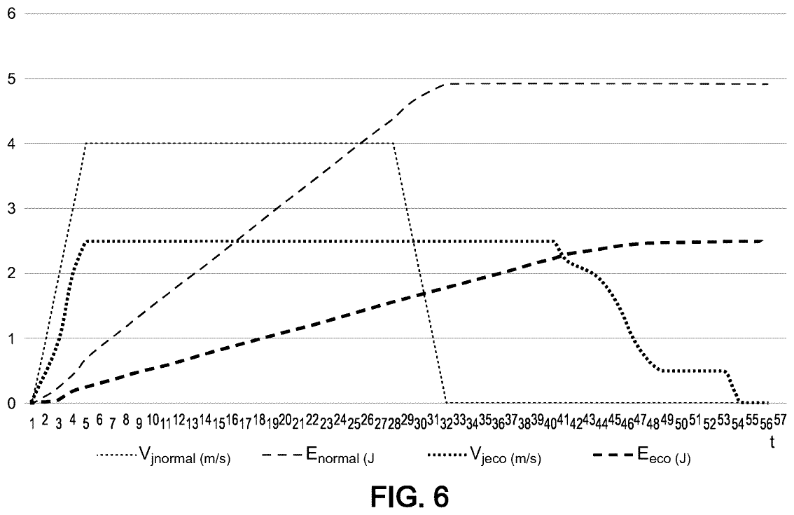

For example, FIG. 6 illustrates the energy loss E by autonomous vehicle 16 when travel speed vⱼ is reduced. One will observe that a reduction of 1.5 m/s in travel speed vⱼ makes it possible to divide almost in half the energy consumption for performing a task. In practice, in “economy” operation, travel speed vⱼ may be 3 m/s. For a task of 120 s, the time to perform the task then increases by 25%, but the amount of energy saved can be reduced by 7%.

According to a fourth step 400, a charging strategy Cⱼ is determined. For example, charging current Iⱼ may be reduced relative to the pre-established default value. Charging time tⱼ may be increased in order to provide the same amount of energy to autonomous vehicle 16 connected to the charging station. The number of active charging stations may also be reduced.

As described above, operating parameters Pⱼ may be common to all the autonomous vehicles in fleet of autonomous vehicles N, facilitating their determination. Alternatively, operating parameters Pⱼ may be determined for each autonomous vehicle j in fleet of autonomous vehicles N. In addition, charging strategy Cⱼ may be common to all charging stations, specific to each charging station, or specific to each autonomous vehicle 16.

One will note that the steps of determining the fleet of autonomous vehicles 200, the operating parameters 300, and the charging strategy 400, may be carried out simultaneously or at least in any order and/or multiple times.

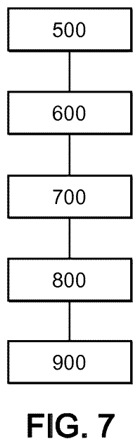

We now describe a method for determining fleet of autonomous vehicles N, operating parameters Pⱼ, and charging strategy Cⱼ, which allows a minimum amount of energy to be consumed, with reference to FIG. 7.

The determining of fleet of autonomous vehicles N, operating parameters Pⱼ, and charging strategy Cⱼ which allow the minimum amount of energy to be consumed, may be carried out upstream of activating “economy” mode. A database may be provided which stores a plurality of tasks to be carried out within a plurality of predetermined durations. For each number of tasks and predetermined duration, there may be an associated fleet of autonomous vehicles N, operating parameters Pⱼ, and charging strategy Cⱼ. The values may thus be found by scanning the database on the basis of the tasks Lₓ and predetermined duration t_{f} at present time to.

According to a first step 500, a plurality of fleets of autonomous vehicles N is defined. The plurality of fleets of autonomous vehicles may take the form of a vector ranging from zero autonomous vehicles to the maximum number Nₘₐₓ of autonomous vehicles.

$$N = [ 0 ; 1 ; … ; j ; … ; {N}_{max} ] \qquad [ MATH . 1 ]$$

According to a second step 600, a plurality of operating parameters Pⱼ are defined. Each operating parameter Pⱼ may be a vector comprising a travel speed vⱼ, an acceleration rate aⱼ, a deceleration rate dⱼ, a vertical ascending acceleration rate caⱼ, a vertical ascending deceleration rate cdⱼ, a vertical descending acceleration rate faⱼ, and a vertical descending deceleration rate fdⱼ. The vectors may be associated with a particular autonomous vehicle j or may be common to fleet of autonomous vehicles N. The acceleration and deceleration rates may be constant or a function of the travel speed.

$${P}_{j} = [ \begin{matrix}{v}_{j} \\ {a}_{j} \\ {d}_{j} \\ {ca}_{j} \\ {cd}_{j} \\ {fa}_{j} \\ {fd}_{j}\end{matrix} ] \qquad [ MATH . 2 ]$$

According to a third step 700, a plurality of energy recharging strategies Cⱼ are defined. Each energy charging strategy Cⱼ may be a vector comprising a charging current Iⱼ and a charging time tⱼ. The vectors may be associated with a particular autonomous vehicle j, with a particular charging station, or may be common to all the charging stations and/or all autonomous vehicles 16.

$${C}_{j} = [ \begin{matrix}{I}_{j} \\ {t}_{j}\end{matrix} ] \qquad [ MATH . 3 ]$$

According to a fourth step 800, an energy loss E is determined for a plurality of combinations of autonomous vehicle fleets N, operating parameters Pⱼ, and energy recharging strategies Cⱼ. The energy loss E is determined as a function of predetermined duration t_{f}. Energy loss E corresponds here to a difference between the amount of electrical energy used E_{elec} and the amount of mechanical energy produced E_{mech} during predetermined duration t_{f}.

$$E ( {t}_{f} ) = {E}_{elec} ( {t}_{f} ) - {E}_{mech} ( {t}_{f} ) \qquad [ MATH . 4 ]$$

The amount of electrical energy used E_{elec} is a function of operating parameters Pⱼ and of charging strategy Cⱼ. Indeed, the amount of electrical energy used E_{elec} corresponds to the electrical energy consumed by system 10 in order to perform tasks Lₓ within predetermined duration t_{f}. The amount of electrical energy used E_{elec} may in particular be calculated according to the following equation.

$${E}_{elec} ( {t}_{f} ) = {\sum }_{j = 0}^{{N}_{max}} {\int }_{{t}_{0}}^{{t}_{f}} {P}_{elecj} ( t , {P}_{j} , {C}_{u} ) . dt \qquad [ MATH . 5 ]$$

The amount of mechanical energy produced E_{mech} is a function of operating parameters Pⱼ. Indeed, mechanical energy produced E_{mech} corresponds to the energy used by the fleet of autonomous vehicles in order to perform the tasks (to move about). The mechanical energy produced E_{mech} may in particular be calculated according to the following equation.

$${E}_{mech} ( {t}_{f} ) = {\sum }_{j = 0}^{{N}_{max}} {\int }_{{t}_{0}}^{{t}_{f}} {P}_{mechj} ( t , {P}_{j} ) . dt \qquad [ MATH . 6 ]$$

One will note that energy loss E may be determined experimentally or by simulation.

According to a fifth step 900, the combination C of: autonomous vehicle fleet N, operating parameters Pⱼ, and charging strategy Cⱼ which have the lowest energy loss E, is selected. Combination C corresponds to the optimal fleet of autonomous vehicles Nₒₚₜᵢ, operating parameters Pⱼ, and charging strategy Cⱼ which are to be used in order to perform the set of tasks within predetermined duration t_{f} while consuming a minimum amount of energy. The combination may be grouped in a vector.

$$C = [ \begin{matrix}{N}_{opti} \\ {P}_{j} \\ {I}_{j}\end{matrix} ] \qquad [ MATH . 7 ]$$

The combinations determined above may be stored in a database and indexed according to predetermined duration t_{f} and the number of tasks Lₓ.

The invention is not limited to the examples described above; on the contrary, it is suitable for numerous variants accessible to those skilled in the art.

For example, one or more among fleet of autonomous vehicles N, energy charging strategy Cⱼ, or operating parameters Pⱼ may be determined. Thus, one or more among fleet of autonomous vehicles N, charging strategy Cⱼ, or operating parameters Pⱼ may be modified relative to the pre-established default values. Determination of the values in “economy” mode may be simplified.

The method for determining fleet of autonomous vehicles N, operating parameters Pⱼ, and charging strategy Cⱼ so as to consume a minimum amount of energy, described above, could be implemented each time it is determined that tasks Lₓ are less than the threshold number of tasks Lₛₑᵤᵢₗ. The determined combination may then be stored in memory. When the tasks and the predetermined duration are again encountered, the processor can select the combination stored in memory. The system can learn and evolve over time.

Furthermore, fleet of autonomous vehicles N, energy charging strategy Cⱼ, or operating parameters Pⱼ may be determined regardless of the number of tasks to be performed. The system may then constantly seek to optimize the energy consumption, without a separate “normal” operating mode.

Furthermore, when predetermined duration t_{f} is greater than a predetermined limit duration t_{inf}, the predetermined duration may be considered to be infinite. In this case, a minimum fleet of autonomous vehicles Nₘᵢₙ, extreme operating parameters Pⱼₑₓₜᵣ, and/or an extreme charging strategy Cⱼₑₓₜᵣ may be selected. The minimum fleet of autonomous vehicles corresponds to the smallest number of autonomous vehicles that enables the tasks to be carried out. The extreme operating parameters are for example the slowest speed and the lowest acceleration rates which allow the lowest possible energy consumption. The charging strategy corresponds to the lowest current and the longest charging time. The amount of energy consumed in order to perform the tasks may be further reduced, since the tasks can be performed over a very long period of time.

The present invention is in no way limited to the type of autonomous vehicle implemented in the energy management method relating thereto.

From the point of view of the movement of said autonomous vehicles, these may be 2-dimensional paths, i.e. in a plane (in the lateral and longitudinal directions x,y only). In this regard, said autonomous vehicles have means of advancement capable of enabling such movements in these two dimensions. The floor of the warehouse or more generally of the recovery and storage system may constitute the plane on which said autonomous vehicles move about. One example illustrating this technology is accessible in patent application WO 2007/149712. According to another configuration, the storage racks arranged in the warehouse define a flat surface at their top, on which the autonomous vehicles can move about. Patent application WO 2015/104263 illustrates this technology, for example.

When the autonomous vehicles have means of ascension, which enable them to move about in three dimensions, the autonomous vehicles may be constructed differently from the autonomous vehicles described above. Examples of autonomous vehicles are described in particular in document WO 2018/189110, but also in documents WO 2020/056175, EP 3 288 865, and WO 2022/089811.

Furthermore, concerning the guidance system of the autonomous vehicle, the system may be other than laser guidance. The guidance system may for example be wire guidance, laser navigation, or optical guidance. Other technologies exist such as GPS guidance and ultrasonic guidance. Autonomous vehicles may also move about by means of mapping and environment recognition techniques.

1.-12. (canceled)

13. A method for energy management in an automated storage and retrieval system, said system comprising a plurality of autonomous vehicles, the method comprising:
determining tasks to be performed within a predetermined duration; and
determining at least one of a fleet of autonomous vehicles to be mobilized to perform the tasks within the predetermined duration, operating parameters of the autonomous vehicles in order to perform the tasks within the predetermined duration, and an energy charging strategy of the autonomous vehicles in order to perform the tasks within the predetermined duration, by:
determining an energy loss, the energy loss being a difference between an amount of electrical energy used and an amount of mechanical energy produced during the predetermined duration, for a plurality of combinations, each combination including at least one of a fleet of autonomous vehicles, operating parameters, and a charging strategy; and
selecting the combination that has the smallest difference so that the amount of energy consumed to perform the tasks within the predetermined duration is minimal, at least when the tasks are below a threshold number of tasks.

14. The method according to claim 13, wherein determining at least one of the fleet of autonomous vehicles, the operating parameters of the autonomous vehicles, and the charging strategy of the autonomous vehicles, is carried out if the tasks are below a threshold number of tasks, and otherwise they take pre-established default values.

15. The method according to claim 13, wherein the operating parameters comprise at least one of: an acceleration rate, a deceleration rate, and a travel speed.

16. The method according to claim 13, wherein each autonomous vehicle is configured to move in a longitudinal direction, a lateral direction, and a vertical direction, and the operating parameters comprise at least one of: a vertical ascending acceleration rate, a vertical ascending deceleration rate, a vertical descending acceleration rate, and a vertical descending deceleration rate.

17. The method according to claim 13, wherein defining the charging strategy comprises selecting a charging current and a charging time.

18. The method according to claim 13, wherein at least one of the operating parameters of the autonomous vehicles and the charging strategy of the autonomous vehicles are identical for each autonomous vehicle in the fleet of autonomous vehicles.

19. The method according to claim 13, wherein the amount of electrical energy used is a function of the number of autonomous vehicles, the operating parameters, and the charging strategy, and wherein the amount of mechanical energy produced is a function of the operating parameters.

20. The method according to claim 13, wherein the combination that presents the lowest energy loss is stored in a database.

21. The method according to claim 13, wherein, when the predetermined duration is greater than a predetermined limit duration, then at least one of a minimum fleet of autonomous vehicles, extreme operating parameters, and an extreme charging strategy are selected.

22. A computer program comprising instructions for implementing the method according to claim 13 when this program is executed by a processor.

23. An automated storage and retrieval system, comprising:
a plurality of autonomous vehicles configured to at least one of retrieve and store items;
at least one autonomous vehicle charging station; and
a processor configured to control at least one of the fleet of autonomous vehicles, the operating parameters of the autonomous vehicles, and the charging strategy, by implementing the method according to claim 13.

24. The automated storage and retrieval system according to claim 23, wherein each autonomous vehicle is configured to move in a longitudinal direction, a transverse direction, and a vertical direction.
